(19) United States
(12) Patent Application Publication
(10) Pub. No.: US 2020/0175607 A1
(43) Pub. Date: Jun. 4, 2020

(54) ELECTRONIC DATA SEGMENTATION SYSTEM

(71) Applicants: Charles Ding, San Francisco, CA (US); Kebin Lu, San Francisco, CA (US); Thomas Shieh, San Francisco, CA (US)

(72) Inventors: Charles Ding, San Francisco, CA (US); Kebin Lu, San Francisco, CA (US); Thomas Shieh, San Francisco, CA (US)

(21) Appl. No.: 16/208,155

(22) Filed: Dec. 3, 2018

(51) Int. Cl. G06Q 40/00; G06F 17/10; G06N 7/00

(52) U.S. Cl. CPC G06Q 40/12; G06N 7/00; G06F 17/10

(57) ABSTRACT

Segmentation algorithms may operate on vast quantities of data to segment the data into a useful data the model. The segmentation data model may then be applied to additional data that may be received in real time. Further, the real time data may be given a score based on the segmentation model and the desires of the user. The segmentation of the data and the score may be returned to a user and the user may determine if additional actions make logical sense based on the score and segmentation.

### BACKGROUND

Electronic data has enormous potential to help businesses but also has the potential to overwhelm businesses. In some situations, the raw data may show potential usefulness but without further analysis, the data may just cause more confusion.

### SUMMARY

Segmentation algorithms may operate on vast quantities of data to segment the data into a useful data the model. The segmentation data model may then be applied to additional data that may be received in real time. Further, the real time data may be given a score based on the segmentation model and the desires of the user. The segmentation of the data and the score may be returned to a user and the user may determine if additional actions make logical sense based on the score and segmentation.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 shows an illustration of an exemplary payment system for segmenting users into groups and using that segmentation on new transactions in the future;

FIG. 2 shows an exemplary machine learning architecture;

FIG. 3 shows an exemplary artificial intelligence architecture;

FIG. 4 is a flowchart of a method for determining segmentation for a plurality of consumers; of FIG. 1;

FIG. 5 is an embodiment of the method for establishing a segmentation analysis for airline travel;

FIG. 6 is an embodiment of method of applying the segmentation analysis to incoming transaction data for airline travel; and

FIG. 7 may illustrate an exemplary computing device that may be physically configured to execute the methods and include the various components described herein.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### Specification

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

At a high level, electronic data has enormous potential to help businesses but also has the potential to overwhelm businesses. In some situations, the raw data may show potential usefulness but without further analysis, the data may just cause more confusion. Segmentation algorithms may operate on vast quantities of data to segment the data into a useful data the model. The segmentation data model may then be applied to additional data that may be received in real time. Further, the real time data may be given a score based on the segmentation model and the desires of the user. The segmentation of the data and the score may be returned to a user and the user may determine if additional actions make logical sense based on the score and segmentation.

In one application, travel purchase data from a plurality of users may be analyzed by a segmentation algorithm. The segmentation algorithm may be used to make a segmentation model which may be applied to travel purchases in real time. Based on the model, the real time data may be given a score and the score may be used to determine if the user making the travel purchase is appropriate for an offer.

From a technical standpoint, the system and method may use specially designed hardware and software to make sure the real time data is categorized quickly enough that a relevant offer may be made to the consumer. Further, using artificial intelligence as part of the classification system may improve on the performance classification of traditional classification algorithms. Artificial intelligence may result in significantly better performance of the classification algorithms.

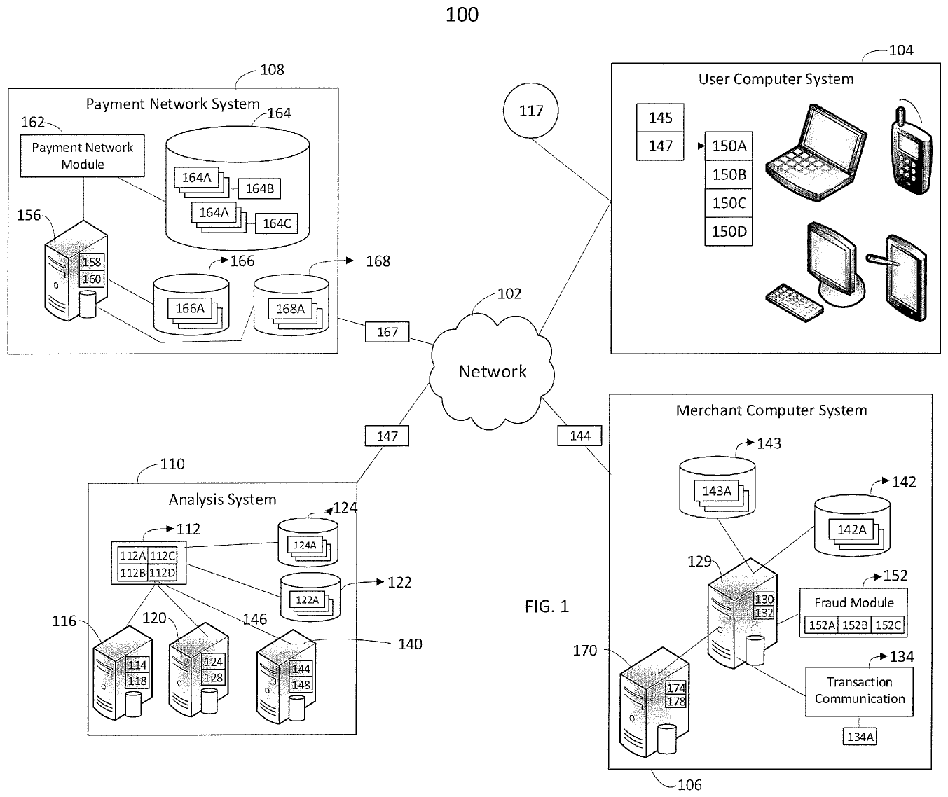

FIG. 1 generally illustrates one embodiment of a payment system 100 for classifying purchases to determine if an additional offer makes logical sense in view of the classification of the consumer. The system 100 may include a computer network 102 that links one or more systems and computer components. In some embodiments, the system 100 includes a user computer system 104, a merchant computer system 106, a payment network system 108, and a transaction analysis system which may embody artificial intelligence 110.

The network 102 may be described variously as a communication link, computer network, internet connection, etc. The system 100 may include various software or computer-executable instructions or components stored on tangible memories and specialized hardware components or modules that employ the software and instructions to identify related transaction nodes for a plurality of transactions by monitoring transaction communications between users and merchants.

The various modules may be implemented as computer-readable storage memories containing computer-readable instructions (i.e., software) for execution by one or more processors of the system 100 within a specialized or unique computing device. The modules may perform the various tasks, methods, blocks, sub-modules, etc., as described herein. The system 100 may also include both hardware and software applications, as well as various data communications channels for communicating data between the various specialized and unique hardware and software components.

Networks are commonly thought to comprise the interconnection and interoperation of hardware, data, and other entities. A computer network, or data network, is a digital telecommunications network which allows nodes to share resources. In computer networks, computing devices exchange data with each other using connections, i.e., data links, between nodes. Hardware networks, for example, may include clients, servers, and intermediary nodes in a graph topology. In a similar fashion, data networks may include data nodes in a graph topology where each node includes related or linked information, software methods, and other data. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications or data network. A computer, other device, set of related data, program, or combination thereof that facilitates, processes information and requests, and/or furthers the passage of information from a source user to a destination user is commonly referred to as a “node.” Networks generally facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

A user computer system 104 may include a processor 145 and memory 147. The user computing system 104 may include a server, a mobile computing device, a smartphone, a tablet computer, a Wi-Fi-enabled device, wearable computing device or other personal computing device capable of wireless or wired communication, a thin client, or other known type of computing device. The memory 147 may include various modules including instructions that, when executed by the processor 145 control the functions of the user computer system generally and integrate the user computer system 104 into the system 100 in particular. For example, some modules may include an operating system 150A, a browser module 150B, a communication module 150C, and an electronic wallet module 150D. In some embodiments, the electronic wallet module 150D and its functions described herein may be incorporated as one or more modules of the user computer system 104. In other embodiments, the electronic wallet module 150D and its functions described herein may be incorporated as one or more sub-modules of the payment network system 108. In some embodiments, a responsible party 117 is in communication with the user computer system 104.

In some embodiments, a module of the user computer system 104 may pass user payment data to other components of the system 100 to facilitate determining a real-time transaction analysis determination. For example, one or more of the operating system 150A, a browser module 150B, a communication module 150C, and an electronic wallet module 150D may pass data to a merchant computer system 106 and/or to the payment network system 108 to facilitate a payment transaction for a good or service. Data passed from the user computer system 104 to other components of the system may include a customer name, a customer ID (e.g., a Personal Account Number or “PAN”), address, current location, and other data.

The merchant computer system 106 may include a computing device such as a merchant server 129 including a processor 130 and memory 132 including components to facilitate transactions with the user computer system 104 and/or a payment device via other entities of the system 100. In some embodiments, the memory 132 may include a transaction communication module 134. The transaction communication module 134 may include instructions to send merchant messages 134A to other entities (e.g., 104, 108, 110) of the system 100 to indicate a transaction has been initiated with the user computer system 104 and/or payment device including payment device data and other data as herein described. The merchant computer system 106 may include a merchant transaction repository 142 and instructions to store payment and other merchant transaction data 142A within the transaction repository 142. The merchant transaction data 142A may only correspond to transactions for products with the particular merchant or group of merchants having a merchant profile (e.g., 164B, 164C) at the payment network system 108.

The merchant computer system 106 may also include a product repository 143 and instructions to store product data 143A within the product repository 143. For each product offered by the merchant computer system 106, the product data 143A may include a product name, a product UPC code, an item description, an item category, an item price, a number of units sold at a given price, a merchant ID, a merchant location, a customer location, a calendar week, a date, a historical price of the product, a merchant phone number(s) and other information related to the product. In some embodiments, the merchant computer system 106 may send merchant payment data corresponding to a payment device to the payment network system 108 or other entities of the system 100, or receive user payment data from the user computer system 104 in an electronic wallet-based or other computer-based transaction between the user computer system 104 and the merchant computer system 106.

The merchant computer system 106 may also include a fraud module 152 having instructions to facilitate determining fraudulent transactions offered by the merchant computer system 106 to the user computer system 104. Thus, the transaction volume analysis and location information may be accurate.

The fraud API 152A may include instructions to access one or more backend components (e.g., the payment network system 108, the artificial intelligence engine 110, etc.) and/or the local fraud module 152 to configure a fraud graphical interface 152B to dynamically present and apply the transaction analysis data 144 to products or services 143A offered by the merchant computer system 106 to the user computer system 104. A merchant historical fraud determination module 152C may include instructions to mine merchant transaction data 143A and determine a list of past fraudulent merchants to obtain historical fraud information on the merchant.

The payment network system 108 may include a payment server 156 including a processor 158 and memory 160. The memory 160 may include a payment network module 162 including instructions to facilitate payment between parties (e.g., one or more users, merchants, etc.) using the payment system 100. The module 162 may be communicably connected to an account holder data repository 164 including payment network account data 164A.

The payment network account data 164A may include any data to facilitate payment and other funds transfers between system entities (e.g., 104, 106). For example, the payment network account data 164A may include account identification data, account history data, payment device data, etc. The module 162 may also be communicably connected to a payment network system transaction repository 166 including payment network system global transaction data 166A.

The global transaction data 166A may include any data corresponding to a transaction employing the system 100 and a payment device. For example, the global transaction data 166A may include, for each transaction across a plurality of merchants, data related to a payment or other transaction using a PAN, account identification data, a product or service name, a product or service UPC code, an item or service description, an item or service category, an item or service price, a number of units sold at a given price, a merchant ID, a merchant location, a merchant phone number(s), a customer location, a calendar week, and a date, corresponding to the product data 143A for the product that was the subject of the transaction or a merchant phone number. The module 162 may also include instructions to send payment messages 167 to other entities and components of the system 100 in order to complete transactions between users of the user computer system 104 and merchants of the merchant computer system 106 who are both account holders within the payment network system 108.

In some embodiments, the global transaction data 166A may be for a travel purchase. Often times, additional data may be included in a travel purchase such in Level 2 or Level 3 data. Level 2 data may include Merchant Name, Transaction Amount, Tax Amount (Between 0.1° A and 31° A of the total amount), Transaction Date, Customer Code or PO number and a Merchant Zip Code. Level 3 data may include data such as Ship-From Zip Code, Destination Zip Code, Invoice Number, Order Number, Item Product Code, Item Commodity Code, Item Description, Item Quantity, Item Unit of Measure, Item Extended Amount, Freight Amount and Duty Amount.

In some embodiments, additional data from third party sources may be acquired to assist the system 100 in creating useful segments. For example, data on hotel stays may be difficult to obtain. However, third parties may have additional data on hotel stays which may be useful in creating segments related to hotel stays. Logically, the amount and detail of the data available may vary and may change based on the desires of the user.

The artificial intelligence engine 110 may include one or more instruction modules including a transaction analysis module 112 that, generally, may include instructions to cause a processor 114 of a transaction analysis server 116 to functionally communicate with a plurality of other computer-executable steps or sub-modules, e.g., sub-modules 112A, 112B, 112C, 112D and components of the system 100 via the network 102. These modules 112A, 112B, 112C, 112D may include instructions that, upon loading into the server memory 118 and execution by one or more computer processors 114, dynamically determine transaction analysis data for a product 143A or a merchant 106 using various stores of data 122A, 124A in one more databases 122, 124. As an example, sub-module 112A may be dedicated to dynamically determine transaction analysis data based on transaction data associated with a merchant 106.

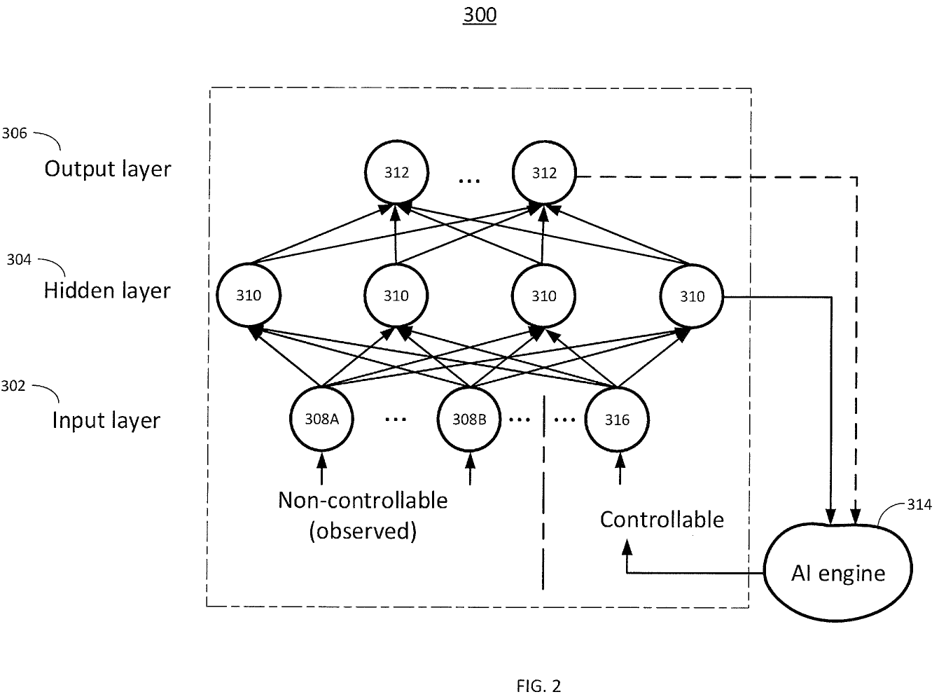

With reference to FIG. 2, a machine learning (ML) architecture 300 may be used with the transaction analysis module 112 of system 100 in accordance with the current disclosure. In some embodiments, an Al module 112D of the artificial intelligence system 110 may include instructions for execution on the processor 114 that implement the ML architecture 300. The ML architecture 300 may include an input layer 302, a hidden layer 304, and an output layer 306. The input layer 302 may include inputs 308A, 308B, etc., coupled to the transaction analysis module 112 and represent those inputs that are observed from actual product, customer, and merchant data in the transaction data 142A, 166A. The hidden layer 304 may include weighted nodes 310 that have been trained for the transactions being observed. Each node 310 of the hidden layer 304 may receive the sum of all inputs 308A, 308B, etc., multiplied by a corresponding weight. The output layer 306 may present various outcomes 312 based on the input values 308A, 308B, etc., and the weighting of the hidden layer 304. Just as a machine learning system for a self-driving car may be trained to determine hazard avoidance actions based on received visual input, the machine learning architecture 300 may be trained to analyze a likely outcome for a given set of inputs based on thousands or even millions of observations of previous customer/merchant transactions. For example, the architecture 300 may be trained to determine transaction analysis data 144 to be associated with the travel data 143A. This provides an insight on the individual customer travel pattern and may also be extended to estimate customer volume patterns at a specific merchant at a given time.

During training of the machine learning architecture 300, a dataset of inputs may be applied and the weights of the hidden layer 310 may be adjusted for the known outcome (e.g., a transaction analysis baseline) associated with that dataset. As more datasets are applied, the weighting accuracy may improve so that the outcome prediction is constantly refined to a more accurate result. In this case, the merchant transaction repository 142 and/or the payment network system repository 166 respectively including transaction data 142A and 166A may provide datasets for initial training and ongoing refining of the machine learning architecture 300.

Additional training of the machine learning architecture 300 may include an artificial intelligence engine (AI engine) 314 providing additional values to one or more controllable inputs 316 so that outcomes may be observed for particular changes to the transaction analysis data 142A and 166A. The values selected may represent different data types such as community responses, merchant ratings and other alternative data presented at various points in the transaction process with the product data and may be generated at random or by a pseudo-random process. By adding controlled variables to the transaction process, over time, the impact may be measured and fed back into the machine learning architecture 300 weighting to allow capture of an impact on a proposed change to the process in order to optimize the determination of the transaction analysis data 144. Over time, the impact of various different data at different points in the transaction cycle may be used to predict an outcome for a given set of observed values at the inputs layer 302.

After training of the machine learning architecture 300 is completed, data from the hidden layer may be fed to the artificial intelligence engine 314 to generate values for controllable input(s) 316 to optimize the transaction analysis data 144. Similarly, data from the output layer may be fed back into the artificial intelligence engine 314 so that the artificial intelligence engine 314 may, in some embodiments, iterate with different data to determine via the trained machine learning architecture 300, whether the transaction analysis data 144 is accurate, and other determinations.

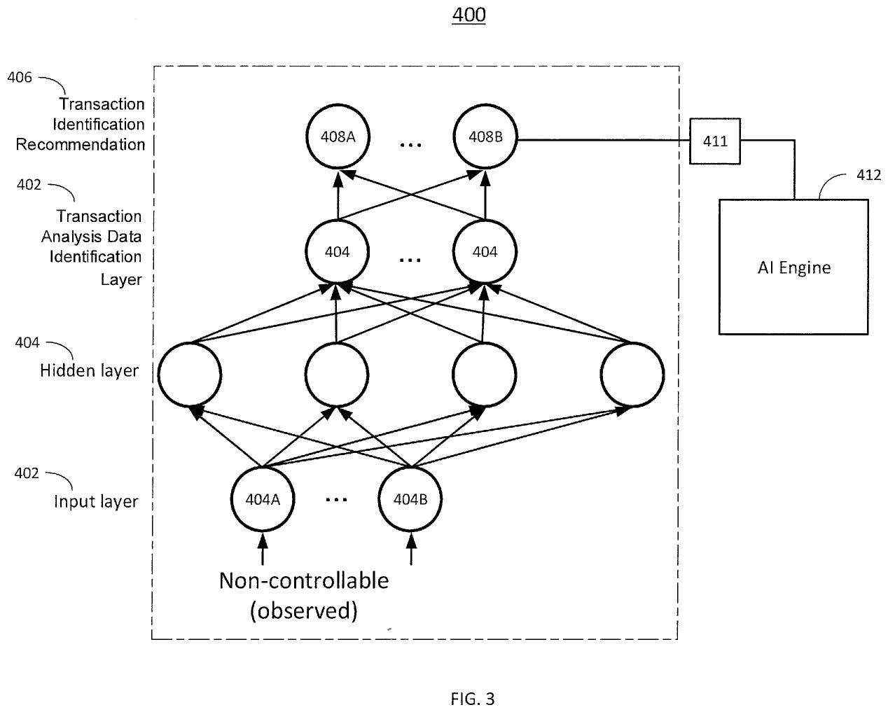

With reference to FIG. 3, in other embodiments, the machine learning architecture 300 and artificial intelligence engine 314 may include a second instance of a machine learning architecture 400 and/or an additional node layer may be used. In some embodiments, a transaction analysis data identification layer 402 may determine an optimum transaction analysis determination 404 from observed inputs 404A, 404B. A transaction analysis layer 406 with outputs 408A, 408B, etc., may be used to generate transaction analysis recommendations 411 to an artificial intelligence engine 412, which in turn, may modify one or more of telephone data generally and the transaction analysis data in particular when communicating this data via an appropriate SDK.

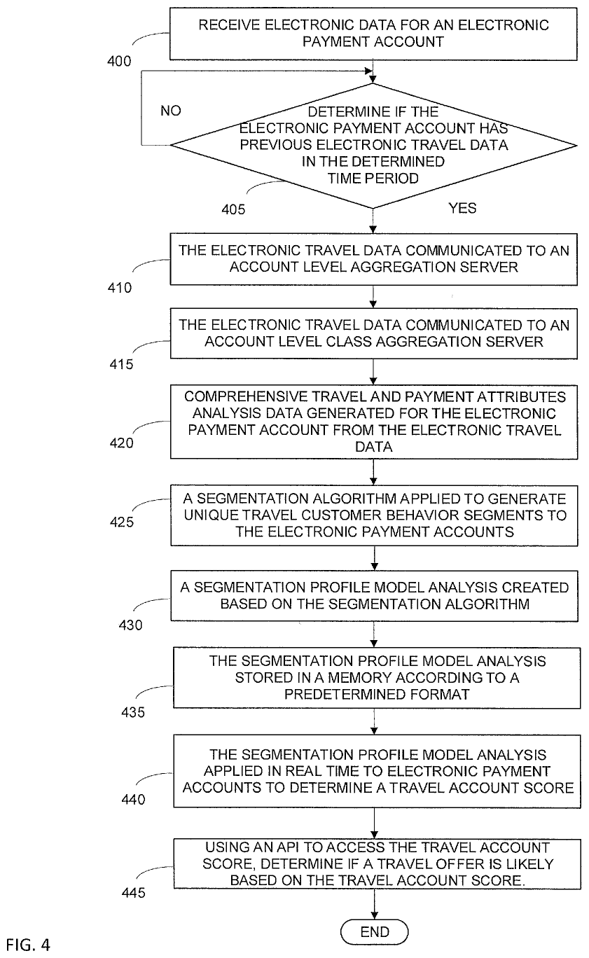

Referring to FIG. 4, a method and computer system 100 for analyzing electronic data at a central clearing server to determine a score for related electronic data in real time may be disclosed. At block 400, at the central clearing server, which may be part of a payment network system 108, may receive electronic data for an electronic payment account. The central clearing server may be a single server like the payment server 156 or a plurality of servers in different geographic locations which work together to be a central clearing point for electronic transactions. At a high level, a central clearing server may be part of the system 100 and may take in a proposed transaction, ensures there are funds to complete the transaction, checks the transaction for possible fraud and if there are funds and an acceptable fraud score, the central clearing server may arrange for the merchant to receive the funds and for the consumer to give up the funds.

The electronic data may be part of the data message 167 and may include data to execute an electronic transaction involving a merchant and an electronic payment account of a consumer. As mentioned earlier, there may be additional details in electronic travel purchase data such as the departure city, the destination city, the class of service, etc.

At block 405, the system 300 and method may determine if the electronic payment account has previous electronic travel data in the determined time period. The determined time period may vary depending on the desires of the user. In some embodiments, the time period may be long such that the user may see if an account has ever purchased travel at a certain level and may be likely to do so in the future. In other embodiments, only purchase data that is more recent may be reviewed. The user of the system 300 may be able to adjust the time period as desired or the system 300 may use past experience to define the time period for the user.

The electronic travel data may take into account a wide variety of travel. In some embodiments, the travel data may be airline specific and may include things like originating city, destination city, class of ticket, etc. In other embodiments, the travel data may include hotel information such as the location, the brand and the level of room selected. In other embodiments, the travel data may include car rental information and any other travel information in the electronic account. Logically, the electronic travel data may include all of parts of the various aspects that make up the travel data universe.

At block 410 if the electronic payment account has a previous electronic travel data during the determined time period, the electronic travel data may be communicated to an account level aggregation server like the server 166. The account level aggregation server 166 may store data on the class level of the travel electronically purchased by the user. For example, if the electronic account flies often, the aggregation server 166 may note that the electronic account is used to fly often. In some embodiments, accounts that represent frequent fliers may be more desirable. The aggregation server 166 may aggregate the data for a plurality of electronic accounts.

At block 415, if the electronic payment account has a previous electronic travel data during the determined time period, the electronic travel data may be communicated to an account level class aggregation server 168. The class aggregation server 168 may aggregate travel class information 168A from a plurality of electronic accounts.

At block 420, in an analysis server such as transaction analysis server 116, comprehensive travel and payment attributes analysis data may be generating for the electronic payment account for a responsible party 117 from the electronic travel data. The attributes may include elements and levels of the elements in the electronic transaction. For example, the elements may include the level of airline class, whether a car is routinely rented, the class of hotel related to the electronic account, whether the electronic account usually rents a car when traveling, etc.

At block 425, in a segmentation server 120, a segmentation algorithm may be applied to generate unique travel customer behavior segments to the electronic payment accounts. The segmentation algorithm may be stored in the segmentation memory 128 and may be executed by the segmentation processor 124. At a high level, the segmentation algorithm may analyze data and determine breakpoints to segment the data. There are a significant number of segmentation algorithms and approaches and all are contemplated as being useful in the system. The specific segmentation algorithm used in the various embodiments may be determined by the user of the system. In other embodiments, the system may select the preferred algorithm. Some sample segmentation algorithms that may work with the system include Gaussian segmentation, k-mean segmentation and weighting segmentation algorithms.

Further, the segmentation may be based on a variety of desired characteristics. Some users may be interested in creating similar economic segments. Other users may be interested in creating segments based on origin city or a destination city. Yet additional users may be interested in a mix of economic factors and travel factors. In addition, the segmentation may be further broken down into clusters and these clusters may be analyzed to provide additional guidance to the segmentation algorithm.

At block 430, in a profile server 140 a segmentation profile model analysis 146 may be created based on the segmentation algorithm. The segmentation algorithm may be stored in the memory 148 and may be executed by the profile server processor 145. At a high level, the segmentation model may learn segment break points from analyzing past transaction data and the segment break points may be applied to new transactions. In other words, new transactions may be placed into segments based on the past transactions using the segmentation profile model analysis 146.

In some embodiments, artificial intelligence as described in relation to FIGS. 3 and 4 may be used to refine the segmentation analysis 146 over time. In these embodiments, the segmentation model analysis 146 may continue to be improved as the artificial intelligence takes in more data over time.

At block 435, the segmentation profile model analysis 146 may be stored in a memory 148 according to a predetermined format. The format may be a schema or a protocol. The protocol may be used such that the model 146 may know in advance what data will be in what spots in the memory. As a result of using the protocol, errors may be minimized as there will be no dispute about what data is in which data field.

At block 440, in an application server 112, the segmentation profile model analysis 146 may be applied in real time to electronic payment accounts with travel activities to determine a travel account score. As mentioned previously, the segmentation profile model analysis 146 may reflect the determined profile using the segmentation algorithm. The model may take in travel purchase data in real time and may apply the segmentation profile to the data. The segmentation placement may then be converted to a score 147. In some embodiments, the score may 147 indicate how well the travel purchase data fits into the segment to which it has been assigned. In other embodiments, users may be able to select one or more segments which are desired and the score 147 may reflect how well the transaction in question matches the desired segment.

At block 445 at a response server 170, it may be determined using an api to access the travel account score if a travel offer from a merchant is likely based on the travel account score. The API may receive a request in a known format and may respond with the score in a known format. The format may be according to a protocol which may be known to users of the system. In some embodiments, the data may be encrypted and it may be unencrypted upon receipt. As mentioned previously, the travel score may represent a classification from a plurality of classifications for the travel data. The score 147 may be compared using the processor 174 to previous scores stored in the memory 178 to determine if the score is over a threshold where an offer would likely be successful. The threshold may be set by the merchant computer system 106 based on a variety of factors such as the desire to add new customers, the capacity of the merchant, the desirability of the specific customers, etc.

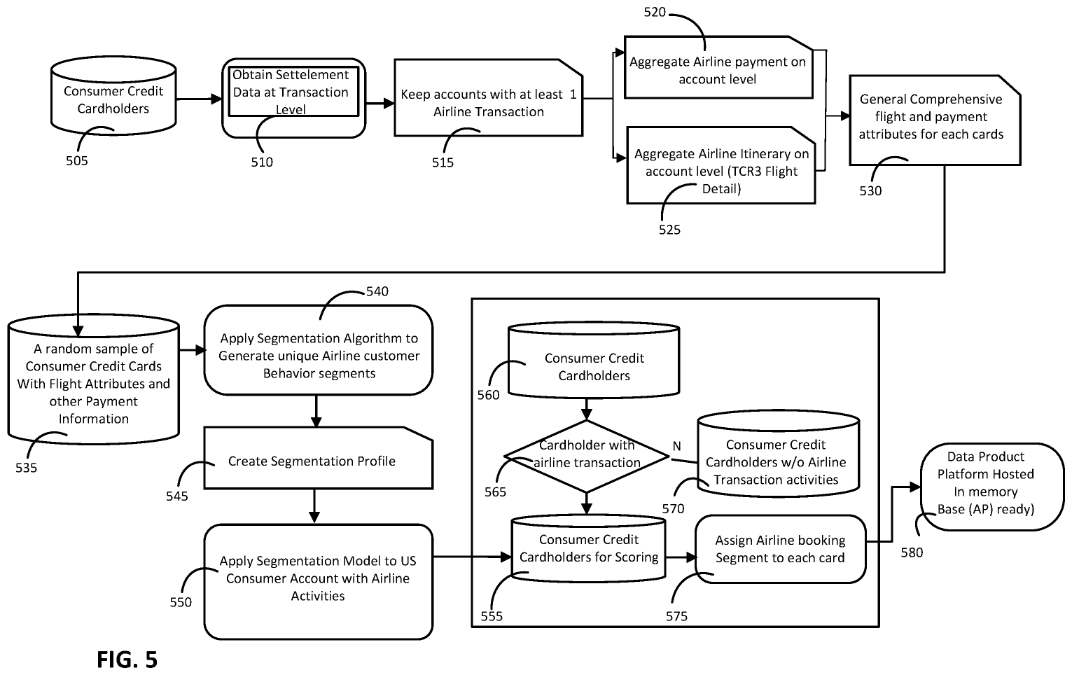

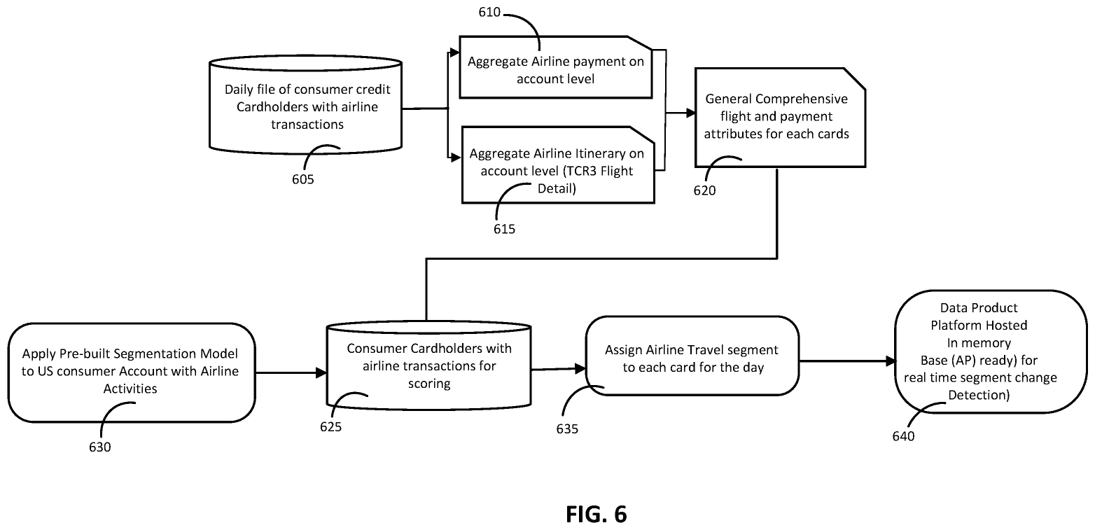

FIGS. 5-6 may be more specific embodiments of the system 100. Referring to FIG. 5 which may describe how the segments are created, the system may be an embodiment that studies flight transactions. At block 505, data from consumer credit cardholders may be obtained such as account numbers and past transaction history. At block 510, settlement data at the transaction level may be obtained. At block 515, accounts that have at least one airline transaction may be determined for further review. At block 520, payment data for accounts with airline transactions may be aggregated on an account level. At block 525, payment data for accounts with airline transactions may be aggregated on a flight detail level such as by the class of tickets purchased. At block 530, comprehensive flight and payment attributes may be generated for each payment accounts that have airline transactions.

At block 535, a random sample of consumer payment accounts with flight attributes and other payment attributes is created. At block 540, a segmentation algorithm may be applied to the random sample to generate unique airline customer behavior segments. At block 545, the system 100 may then create a segmentation profile model and at block 550, the segmentation model may be stored to be applied to consumer accounts with airline activities at block 555.

At block 560, data on consumer credit cardholders may be accessed. At block 565, the system 100 may determine if the cardholder under analysis has airline transactions during the relevant time period. If not, control may pass to block 570 where the cardholder may be added to a memory with other consumer credit cardholders without airline transaction activities. If the cardholder under analysis has an airline transaction during the relevant time period as determined at block 565, the cardholder may be added to the previously determined cardholder that have airline transactions at block 555 and a booking segment may be assigned to each payment account at block 575. At block 580, the payment accounts broken into segments according to the segmentation algorithm may be hosted in a memory which may be accessible by an API.

In some embodiments, the payment network system 108 may drive the system 100 and the payment network system may see virtually all transactions that flow through the payment network. Thus, the payment network system 108 may be able to recognize that a first payment account and a second payment account may belong to a single user or a single family. By making this recognitions, the payments accounts may be combined for analysis purposes to provide a more realistic view of the segments in action. As a payment account issuer may only have access to a single payment account, the payment network system may have access to all payment devices and a more complete picture may be created for each user. In addition, if more data is obtained from third parties such as demographic data, income, address, general spend behavior, etc., the segments may be further refined and may have improved segmentation.

FIG. 6 may be an illustration of applying the segmentation model created in FIG. 6 to new transactions in virtually real time. At block 605, a daily file of consumer transactions with airline transactions may be received. At block 610, the received consumer transactions may be aggregated with previous airline payment accounts on an account level and at block 615, the received consumer transactions may be aggregated with previous airline payment accounts on a level of service basis. At block 620, general comprehensive flight and payment attributes may be determined for each payment accounts. At block 625, the general comprehensive flight and payment attributes for each payment device may be added to the file of credit cardholders with airline transactions for scoring. At block 630, the previously created segmentation model may be applied to the file from block 625. At block 635, a travel segment may be assigned to each payment device for the day and at block 640, the segmentation data may be available for access using an API.

A similar process may occur for hotel data and for car rental data. The decisions would change from determining if the payment device had previous airline transactions during the relevant time period to determining if the payment device has previous hotel transactions during the relevant time period, but the aggregation and segmentation processes may follow the same logic as the airline logic.

The system 100 may use the segments and clusters in additional ways. In one embodiment, an application may be created that is user facing and users may be able to see data about similar travelers. For example, if a user is traveling to Prague for the first time, the user may be able to see what hotel similar users in a same segment or cluster have used or what tourist sites the similar travelers have visited. In addition, users may view what people in different clusters have seen in Prague or where different clusters have stayed in Prague, for example. Finally, the payment network 108 or merchants may be able to create offers which may be deemed to be especially useful to people in the various segments or clusters when they traveled to Prague, for example.

In yet another example, the system 100 may be merchant facing and the system 100 may use the segments to identify users which may be likely to be interested in a good or service offered by the merchant. For example, if an airline has to move a plane from Chicago to Omaha on short notice, the system 100 may be able to identify segments or clusters of users that purchase flights on short notice, may originate in Chicago and may use the destination of Omaha. The merchant may then be able to contact these users and offer the Chicago to Omaha flight.

Similarly, the system 100 may be used to predict if a new route or high end hotel may be successful. As an example, if a hotel is considering a new high end hotel in Phoenix, the merchant may be able to inquire of the segments that often use high end hotels and that often travel to Phoenix which may indicate a high end hotel in Phoenix may make sense. Further, individuals in the relevant segments may be contacted to see if they would be likely to use a high end hotel in Phoenix.

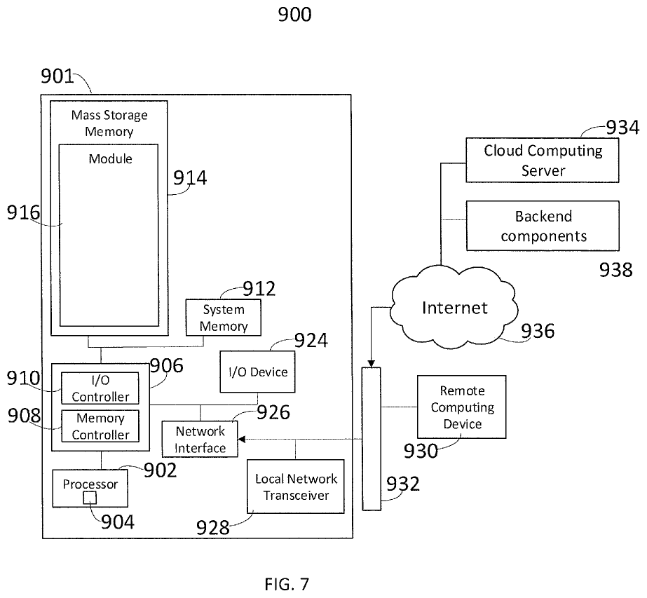

FIG. 7 may be a sample computing device used by the system 100. The various servers 116, 120, 140, 156, 129, 170 may have a similar design but the servers may be modified to specifically excel at the services provided. The computing device 901 may include a processor 902 that is coupled to an interconnection bus. The processor 902 includes a register set or register space 904, which is depicted in FIG. 5 as being entirely on-chip, but which could alternatively be located entirely or partially off-chip and directly coupled to the processor 902 via dedicated electrical connections and/or via the interconnection bus. The processor 902 may be any suitable processor, processing unit or microprocessor. Although not shown in FIG. 5, the computing device 901 may be a multi-processor device and, thus, may include one or more additional processors that are identical or similar to the processor 902 and that are communicatively coupled to the interconnection bus.

The processor 902 of FIG. 7 is coupled to a chipset 906, which includes a memory controller 908 and a peripheral input/output (I/O) controller 910. As is well known, a chipset typically provides I/O and memory management functions as well as a plurality of general purpose and/or special purpose registers, timers, etc. that are accessible or used by one or more processors coupled to the chipset 906. The memory controller 908 performs functions that enable the processor 902 (or processors if there are multiple processors) to access a system memory 912 and a mass storage memory 914, that may include either or both of an in-memory cache (e.g., a cache within the memory 912) or an on-disk cache (e.g., a cache within the mass storage memory 914).

The system memory 912 may include any desired type of volatile and/or non-volatile memory such as, for example, static random access memory (SRAM), dynamic random access memory (DRAM), flash memory, read-only memory (ROM), etc. The mass storage memory 914 may include any desired type of mass storage device. For example, the computing device 901 may be used to implement a module 916 (e.g., the various modules as herein described). The mass storage memory 914 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 901, the systems and methods described herein. Thus, a module, block, function, operation, procedure, routine, step, and method can be implemented in hardware, firmware, and/or software. In one embodiment, program modules and routines are stored in mass storage memory 914, loaded into system memory 912, and executed by a processor 902 or can be provided from computer program products that are stored in tangible computer-readable storage mediums (e.g. RAM, hard disk, optical/magnetic media, etc.).

The peripheral I/O controller 910 performs functions that enable the processor 902 to communicate with a peripheral input/output (I/O) device 924, a network interface 926, a local network transceiver 928, (via the network interface 926) via a peripheral I/O bus. The I/O device 924 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 924 may be used with the module 916, etc., to receive data from the transceiver 928, send the data to the components of the system 100, and perform any operations related to the methods as described herein. The local network transceiver 928 may include support for a Wi-Fi network, Bluetooth, Infrared, cellular, or other wireless data transmission protocols. In other embodiments, one element may simultaneously support each of the various wireless protocols employed by the computing device 901. For example, a software-defined radio may be able to support multiple protocols via downloadable instructions. In operation, the computing device 901 may be able to periodically poll for visible wireless network transmitters (both cellular and local network) on a periodic basis. Such polling may be possible even while normal wireless traffic is being supported on the computing device 901. The network interface 926 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 908 and the I/O controller 910 are depicted in FIG. 6 as separate functional blocks within the chipset 906, the functions performed by these blocks may be integrated within a single integrated circuit or may be implemented using two or more separate integrated circuits. The computing environment 900 may also implement the module 916 on a remote computing device 930. The remote computing device 930 may communicate with the computing device 901 over an Ethernet link 932. In some embodiments, the module 916 may be retrieved by the computing device 901 from a cloud computing server 934 via the Internet 936. When using the cloud computing server 934, the retrieved module 916 may be programmatically linked with the computing device 901. The module 916 may be a collection of various software platforms including artificial intelligence software and document creation software or may also be a Java® applet executing within a Java® Virtual Machine (JVM) environment resident in the computing device 901 or the remote computing device 930. The module 916 may also be a “plug-in” adapted to execute in a web-browser located on the computing devices 901 and 930. In some embodiments, the module 916 may communicate with back end components 938 via the Internet 936.

The system 900 may include but is not limited to any combination of a LAN, a MAN, a WAN, a mobile, a wired or wireless network, a private network, or a virtual private network. Moreover, while only one remote computing device 930 is illustrated in FIG. 7 to simplify and clarify the description, it is understood that any number of client computers are supported and can be in communication within the system 900.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A computer system for analyzing electronic transaction data at a central clearing server to determine a score for related electronic data in real time comprising:
at the central clearing server,
receiving electronic data for an electronic payment account;
determining if the electronic payment account has previous electronic travel data in a determined time period;
if the electronic payment account has a previous electronic travel data,
communicating the electronic travel data to an account level aggregation server;
communicating the electronic travel data on an account level class aggregation server;
in an analysis server, generating comprehensive travel and payment attributes analysis data for the electronic payment account from the electronic travel data;
in a segmentation server, applying a segmentation algorithm to generate unique travel customer behavior segments to the electronic payment accounts;
in a profile server,
creating segmentation profile model analysis based on the segmentation algorithm;
storing segmentation profile model analysis in a memory according to a predetermined format;
in an application server, applying segmentation profile model analysis in real time to electronic payment accounts with travel activities to determine a travel account score; and
at a response server, using an api to access the travel account score to determine if a travel offer is likely based on the travel account score.

2. The computer system of claim 1, wherein the central clearing server clears electronic transactions.

3. The computer system of claim 2, wherein the electronic data comprises data to execute an electronic transaction involving a merchant and an electronic payment account of a consumer.

4. The computer system of claim 1, wherein the account level class aggregation server stores data on a class level of travel electronically purchased by a consumer.

5. The computer system of claim 1, wherein attributes comprises elements and levels of the elements in the electronic transaction.

6. The computer system of claim 1, wherein the segmentation algorithm analyzes data and determines breakpoints to segment the data.

7. The computer system of claim 1, wherein the segmentation profile model analysis reflects the determined segmentation profile using the segmentation algorithm and takes in data and segments the data in a similar manner.

8. The computer system of claim 1, wherein the travel account score represents a classification from a plurality of classifications for the electronic travel data.

9. The computer system of claim 1, wherein the api takes in a request in a known format and responds with a travel score according to a known protocol.

10. The computer system of claim 9, wherein the travel account score is communicated according to a predetermined protocol.

11. A computer system for accessing electronic data from a central server that has been segmented by determined scores comprising:
at a central clearing server,
receiving electronic data for an electronic payment account;
determining if the electronic payment account has previous electronic travel data in a determined time period;
if the electronic payment account has previous electronic travel data,
communicating the electronic travel data to an account level aggregation server;
communicating the electronic travel data on an account level class aggregation server;
in an analysis server, generating comprehensive travel and payment attributes analysis data for the electronic payment account from the electronic travel data;
in a segmentation server, applying a segmentation algorithm to generate unique travel customer behavior segments to the electronic payment accounts;
in a profile server,
creating segmentation profile model analysis based on the segmentation algorithm;
storing segmentation profile model analysis in a memory according to a predetermined format;
in an application server, applying segmentation profile model analysis in real time to electronic payment accounts with travel activities to determine a travel account score; and
at a response server, using an api to access the travel account score to determine if a travel offer is likely based on the travel account score.

12. The computer system of claim 11, wherein a central clearing server clears electronic transactions.

13. The computer system of claim 12, wherein the electronic data comprises data to execute an electronic transaction involving a merchant and an electronic payment account of a consumer.

14. The computer system of claim 11, wherein the account level class aggregation server stores data on a class level of the travel electronically purchased by a consumer.

15. The computer system of claim 11, wherein attributes comprises elements and levels of the elements in the electronic travel transaction.

16. The computer system of claim 11, wherein the segmentation algorithm analyzes data and determines breakpoints to segment the data.

17. The computer system of claim 11, wherein the segmentation profile model analysis reflects the determined segmentation profile using the segmentation algorithm and takes in data and segments the data in a similar manner.

18. The computer system of claim 11, wherein the travel account score represents a classification from a plurality of classifications for the electronic travel data.

19. The computer system of claim 11, wherein the api takes in a request in a known format and responds with a travel score according to a known protocol.

20. The computer system of claim 19, wherein the travel score is communicated according to a predetermined protocol.
